(19) United States
(12) Patent Application Publication
(10) Pub. No.: US 2021/0306266 A1
(43) Pub. Date: Sep. 30, 2021

(54) CIRCUITRY APPLIED IN NETWORK DEVICE AND ASSOCIATED OPERATING METHOD

(71) Applicant: Realtek Semiconductor Corp., HsinChu (TW)

(72) Inventors: Jeong-Fa Sheu, HsinChu (TW); Jun-An Ding, HsinChu (TW); Tzung-Jin Wu, HsinChu (TW)

(21) Appl. No.: 17/203,707

(22) Filed: Mar. 16, 2021

(30) Foreign Application Priority Data
Mar. 24, 2020 (TW) 109109765

(51) Int. Cl. H04L 12/741; H04L 12/721; H04L 12/717

(52) U.S. Cl. CPC H04L 45/745; H04L 45/42; H04L 45/566

(57) ABSTRACT

A circuitry applied in a network device is disclosed. The circuitry includes multiple ports, a processor port, a packet buffer, a control circuit and a parser, where the processor port is coupled to a memory and a processor via a bus. In operations of the circuitry, the packet buffer stores a packet received from one of the multiple ports. The parser analyzes the packet to determine a processing manner of the packet, and when the parser determines that the packet is to be processed by software, the control circuit delivers contents of the packet to the memory via the processor port in multiple segments or all at once, for software analysis executed by the processor.

### BACKGROUND OF THE INVENTION

### 1. Field of the Invention

The present invention is related to a circuitry within a device for delivering network packets to a processor, and an associated operating method.

### 2. Description of the Prior Art

In a network communications device (e.g. a network device) positioned in a switch or a router, a network device may have multiple ports for receiving or outputting packets. When the network device receives a packet, the network device may perform inquiry via an internal hardware circuit and a look-up table to determine from which port to send out the packet. If the hardware circuit determines that this process requires software to be involved, the hardware circuit may deliver the packet to a central processor, for using software processing to determine whether to correct the packet or determine a destination of the packet.

Forwarding the packet via the hardware circuit is faster, but software will be required if there is no related information of the received packet in the look-up table or the hardware cannot identify a format of the packet, meaning the hardware circuit cannot process the packet. Although software transmission can deal with all packet formats, in practice, the hardware circuit may first move the whole packet to a memory that is accessible for a processor when the processing fails, and the central processor may further read packet contents from the memory later for performing software analysis to properly handle the packet.

This conventional method may need more memory spaces and may occupy greater bus bandwidth, which degrades system performance, particularly when the frame is a Jumbo frame which will impact the performance even more severely.

### SUMMARY OF THE INVENTION

Thus, an objective of the present invention is to provide a technique applied in a network device, which can effectively reduce the impact upon the system performance when the central processor processes a packet by software, to solve the problem of the related art.

In an embodiment of the present invention, a circuitry applied in a network device is disclosed. The circuitry comprises at least one port, a processor port, a packet buffer, a control circuit and a parser, where the processor port is coupled to a memory and a processor via a bus. In operations of the circuitry, the packet buffer stores a packet received from one of the at least one port. The parser analyzes the packet to determine a processing manner of the packet. When the parser is not able to determine the processing manner regarding the packet or determine that the packet need to be processed by software, the control circuit may segmentally deliver a partial content of the packet or deliver all contents at once to the memory via the processor port by a software setting, for being analyzed by the processor.

In another embodiment of the present invention, an operating method of a network device is disclosed. The operating method comprises the following steps: receiving a packet; storing the packet into a packet buffer; analyzing the packet to determine a processing manner of the packet; and when the processing manner is not able to be determined or when determining that the packet needs to be processed by software, segmentally delivering a partial content of the packet or delivering all contents at once to the memory by software setting, for being analyzed by a processor.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a network device according to an embodiment of the present invention.

FIGS. 2A and 2B are flowcharts illustrating operations of a network device according to an embodiment of the present invention.

FIG. 3 is a diagram illustrating a structure of a packet received by a circuitry.

### DETAILED DESCRIPTION

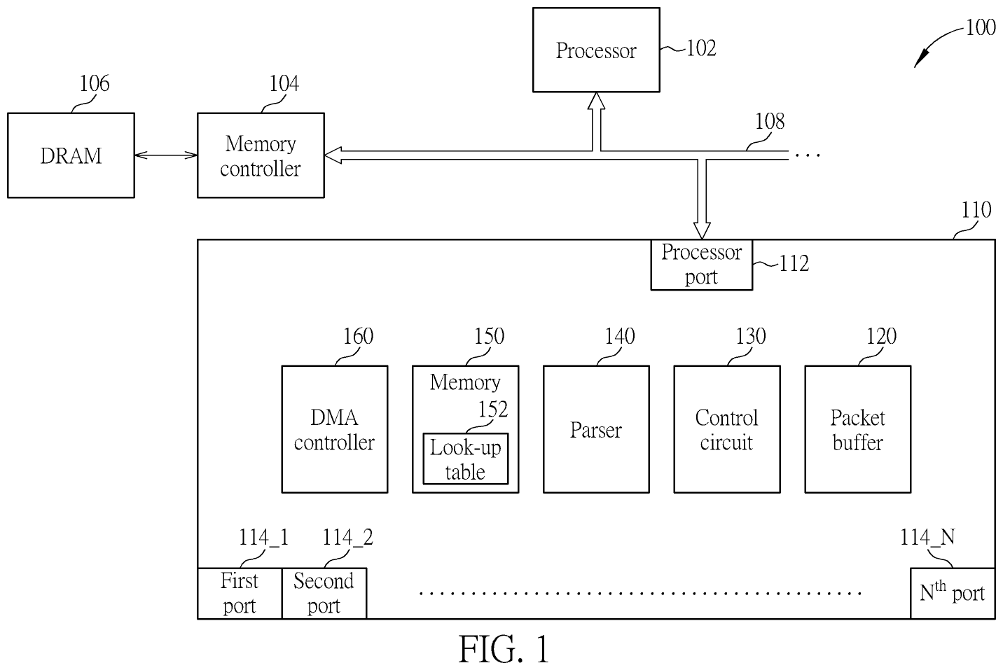

FIG. 1 is a diagram illustrating a network device 100 according to an embodiment of the present invention, where the network device 100 in this embodiment may be a switch or a router. As shown in FIG. 1, the network device 100 comprises a processor 102, a memory controller 104 and a dynamic random access memory (DRAM) 106, where a circuitry 110 comprises a processor port 112, multiple ports 114_1 to 114_N, a packet buffer 120, a control circuit 130, a parser 140, a memory 150 comprising at least one look-up table 152, and a direct memory access (DMA) controller 160. FIG. 1 is for illustrative purposes only, and the network device 100 is not limited to the switch or the router. In another embodiment, ports included in the network device 100 may at least comprise a physical port. In the circuitry 110, the processor port 112 is configured to be coupled to the processor and the memory controller 104 via a bus 108 (e.g. a bus is utilized between the processor port 112 and the memory controller 104; or a bus is utilized between the processor 102 and the memory controller 104). The multiple ports 114_1 to 114_N are configured to be coupled to other electronic devices via a local area network (LAN) or a wide area network (WAN). The packet buffer 120 is configured to temporarily store packets that have come from outside and are waiting to be forwarded. The memory controller 104 is configured to receive commands on the bus 108 and perform write or read operations upon the DRAM 106.

It should be noted that, in the embodiment shown in FIG. 1, DRAM 106 may be any memory that may be directly accessed by the processor 102, e.g. a static random access memory (SRAM).

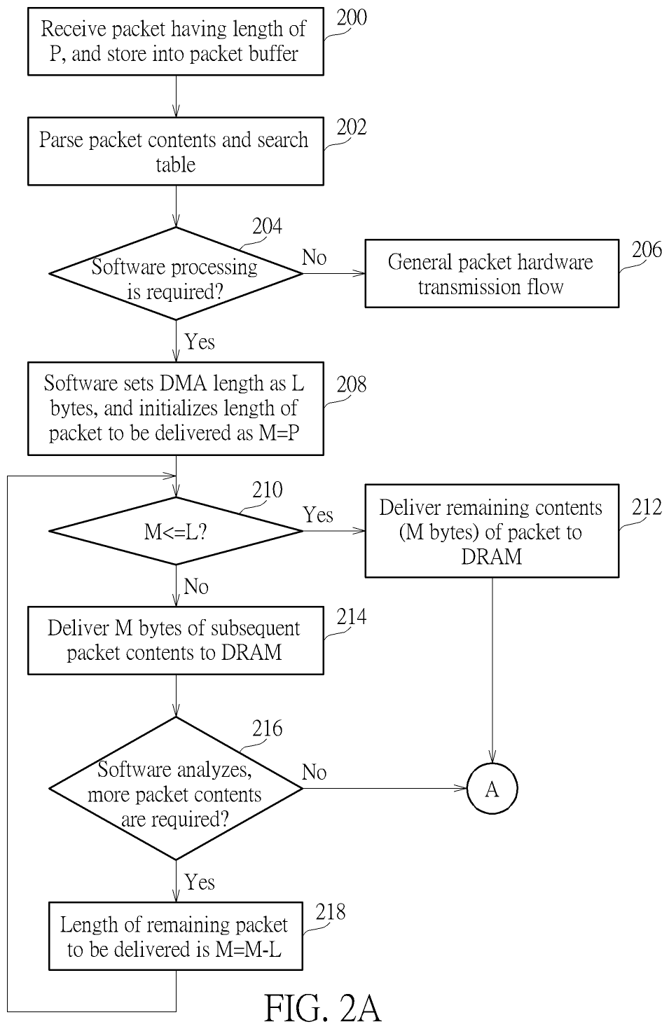

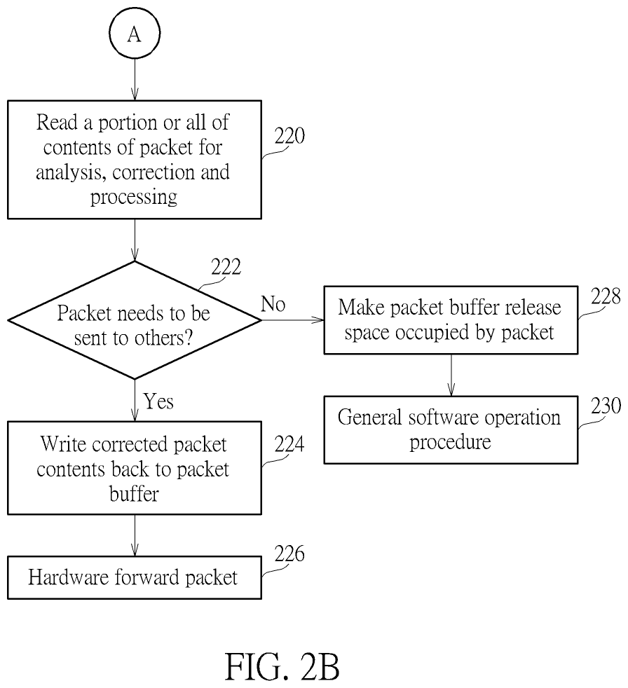

FIGS. 2A and 2B are flowcharts illustrating operations of the network device 100 according to embodiments of the present invention. In Step 200, the circuitry 110 receives a packet having a length of P bytes from the LAN or WAN via one of the multiple ports 114_1 to 114_N, e.g. the first port 114_1, and stores the packet into the packet buffer 120. In Step 202, the parser 140 parses packet contents of the packet stored in the packet buffer 120, and searches the related look-up table 152. As the parser 140 and related contents to be searched in the look-up table 152 are well-known by those skilled in this art, related details are omitted here for brevity. In Step 204, the control circuit 130 determines how to process the packet according to a determination of the parser 140 and searching results of the look-up table. If software processing is not required, the flow enters a general hardware transmission flow as shown in Step 206. As related descriptions of the general hardware transmission flow are well-known by those skilled in this art, details are omitted here for brevity. If the software processing is required (e.g. the parser 140 cannot determine which port the packet is going to be sent out from), the flow enters Step 208, where the circuitry 110 initializes a length variable M of the packet to be delivered as a packet total length P first, and decides a basic unit length of every DMA transmission (i.e. a transmission basic unit length of the DMA controller 160) to be L bytes according to a software setting.

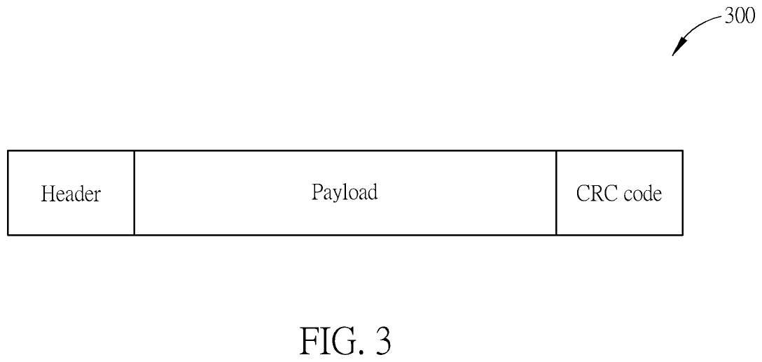

In Step 208, regarding details of the transmission basic unit length L of DMA, refer to FIG. 3, which is a diagram illustrating a structure of a packet 300 received by the circuitry 110. The packet 300 mainly comprises a header, a payload and a cyclic redundancy check (CRC) code. Information required for packet searching and processing is usually included in the header, and only a few packets may need analysis regarding contents of the payload. Thus, for a purpose of reducing bandwidth of the bus 108 and power consumption, the control circuit 130 controls the DMA controller 160, and only delivers partial content of a packet to the DRAM 106 where it is stored via the memory controller 104. In one embodiment, the control circuit 130 may only deliver the header of the packet 300 to the DRAM 106; the packet buffer 120 still stores complete contents of the packet 300. In another embodiment, the control circuit 130 may deliver a content with a fixed length starting from the header within the packet 300, e.g. the first 8 bytes or the first 12 bytes (which might comprise all the header contents or merely comprise a portion of the header contents) of the packet 300 to the DRAM 106. In another embodiment, the look-up table 152 may comprise a first transmission length look-up table, where the first look-up table may comprise multiple frame/packet types and a corresponding DMA transmission basic unit length (L). For example, the frame/packet types may comprise a wireless LAN frame, an internet control message protocol (ICMP) frame, a user datagram protocol (UDP) packet, a transmission control protocol (TCP), etc. Each frame/packet type has a corresponding DMA transmission basic unit length, e.g. the TCP packet corresponds to 12 bytes and the ICMP frame corresponds to 16 bytes. The control circuit 130 and the DMA controller 160 may determine how many bytes (L) are going to be delivered to the DRAM 106 according to a frame/packet type of the received packet 300. In another embodiment, the look-up table 152 may comprise a second transmission length look-up table, where the second transmission length look-up table comprises multiple priorities and corresponding DMA transmission lengths (L). For example, a packet having the highest priority corresponds to 4 bytes, a packet having the second high priority corresponds to 6 bytes, a packet having the third high priority corresponds to 8 bytes, etc. The control circuit 130 and the DMA controller 160 may determine how many bytes (L) are going to be delivered to the DRAM 106 according to importance or a priority of the received packet 300, where the importance or the priority of the packet 300 may be determined by a type of the packet 300, which port the packet 300 enters the circuitry 100 from, a source address, a target address, a header information, or any other related information. In another embodiment, the look-up table 152 comprises both the first transmission length look-up table and the second transmission length look-up table, and the control circuit 130 and the DMA controller 160 may determine how many bytes are going to be delivered to the DRAM 106 according to the first transmission length look-up table and the second transmission length look-up table. For example, if transmission lengths are found in both of the first transmission length look-up table and the second transmission length look-up table, the greater transmission length may be selected; or priorities of the first transmission length look-up table and the second transmission length look-up table may be set. In the second case, if transmission lengths are found in both of the first transmission length look-up table and the second transmission length look-up table, the transmission length decided by the transmission length look-up table having the higher priority may be selected.

The flow then enters Step 210 to determine whether the transmission packet length variable M is less than the DMA transmission basic unit length L. If M is less than or equal to L, the flow enters Step 212 to deliver the remaining contents of the packet to the DRAM 106; otherwise, the flow enters Step 214. In Step 214, the packet is delivered to the DRAM according to L bytes of contents following the last DMA transmission. If it is the first time the DMA controller 160 delivers data of the packet to the DRAM 106, the DMA controller 160 delivers L bytes of contents starting from the header of the packet.

After the control circuit 130 and the DMA contro11er160 deliver partial contents of the packet to the DRAM 106, the control circuit 130 may inform the processor 102 via the processor port 112, and notify that partial contents of the packet 300 have been delivered to the DRAM 106. The DRAM 106 may be replaced with any other type of memory in another embodiment.

The flow then enters Step 216. The software reads packet contents that have been delivered to the DRAM 106, and performs analysis to determine whether it is required to keep reading the packet contents remaining in the packet buffer. If yes, the flow enters Step 218 to update the transmission packet length variable M (the original value M minus L bytes that were previously delivered to the DRAM 106 by DMA), and enters Step 210 again. Related descriptions of Step 210 may be known by referring to the relevant description above, and are omitted here for brevity. In another embodiment, this DMA transmission basic unit length L may be set as different values in every DMA by software setting.

When the flow determines that it is not required to keep reading the packet contents remaining in the packet buffer in Step 216, the flow enters Step 220. Similarly, Step 212 is also followed by Step 220, which means a procedure of delivering the packet contents from the DMA controller 160 to the DRAM 106 has finished.

Refer to FIG. 2B. The software reads a portion or all of the contents of the packet delivered from the DRAM 106 by the DMA controller 160 in Step 220, and performs analysis and correction. The flow then enters Step 222 to determine whether the packet 300 needs to be forwarded to other electronic devices via one of the multiple ports 114_1 to 114_N; if yes, the flow enters Step 224; otherwise, the flow enters Step 228.

In Step 228, the software sends an command to make the packet buffer release the memory space occupied by the packet. The flow then enters a general conventional software operation following Step 230, which is omitted here for brevity.

In Step 224, the software sends an command to make a partial content that has been corrected in the DRAM 106 be written back to the packet buffer through the DMA controller 160, and replaces a partial content of the original packet to finish the update. The packet is then sent out via a target port in Step 226.

It should be noted that parts of the above description relating to software analysis are well-known by those skilled in this art; the main focus of this embodiment is segmentally forwarding the packet 300 for the processor 102 to perform software analysis. Details relating to software analysis are therefore omitted here for brevity.

Briefly summarized, in the circuitry applied in a network device of the present invention, when a hardware circuit is unable to determine whether to transfer information regarding a packet, or to which processor port the packet should be transferred to, the circuitry can deliver a partial content of the packet to the DRAM for the processor to perform software analysis. In one embodiment, the partial content comprises most information (e.g. a header) that is required for packet searching. Thus, under most conditions, the processor may merely read the partial content of the packet to determine subsequent processing manners of the packet without completely analyzing the whole packet contents. Utilized bandwidth of the DRAM can be effectively reduced, and execution efficiency of related circuits may be increased while power consumption can be reduced.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A circuitry applied in a network device, the circuitry comprising:
at least one port;
a processor port, coupled to a memory and a processor via a bus;
a packet buffer, configured to store a packet received from the at least one port;
a control circuit, configured to control operations of the circuitry; and
a parser, configured to analyze the packet to determine a processing manner of the packet;
wherein when the parser determines that the packet needs to be processed by software, the control circuit delivers a partial content of the packet to the memory via the processor port, for analysis by the processor.

2. The circuitry of claim 1, wherein the partial content of the packet comprises a header of the packet.

3. The circuitry of claim 1, wherein the partial content delivered by the control circuit into the memory comprises a content with a fixed length starting from a header within the packet.

4. The circuitry of claim 1, further comprising:
a first transmission length look-up table, recording multiple frame/packet types and corresponding transmission lengths;
wherein the control circuit decides a transmission length according to a frame/packet type of the packet, and delivers the partial content having the transmission length within the packet into the memory.

5. The circuitry of claim 1, further comprising:
a second transmission length look-up table, recording multiple priorities and corresponding transmission lengths;
wherein the control circuit decides a transmission length according to importance or a priority of the packet, and delivers the partial content having the transmission length within the packet into the memory.

6. The circuitry of claim 1, further comprising:
a first transmission length look-up table, recording multiple frame/packet types and corresponding transmission lengths; and
a second transmission length look-up table, recording multiple priorities and corresponding transmission lengths;
wherein the control circuit decides a transmission length according to a frame/packet type of the packet and/or importance or a priority of the packet, and delivers the partial content having the transmission length within the packet into the memory.

7. The circuitry of claim 1, wherein after the control circuit delivers the partial content of the packet to the memory via the processor port, and after a notification from the processor is received, the control circuit corrects the packet stored in the packet buffer according to a corrected content of the partial content stored in the memory which is corrected by the processor, to generate a corrected packet; and the control circuit forwards the corrected packet to an electronic device outside the network device.

8. The circuitry of claim 1, wherein after the control circuit merely delivers a partial content of the packet to the memory via the processor port, the packet buffer stores complete contents of the packet.

9. The circuitry of claim 1, wherein the control circuit segmentally delivers data contents following the partial content to the memory via the processor port, until the processor does not need to analyze subsequent data or all contents of the packet have been sent to the memory.

10. The circuitry of claim 1, wherein in response to a request of the processor, the control circuit delivers the remaining contents of the packet to the memory via the processor port, for being analyzed by the processor.

11. An operating method of a network device, the method comprising:
receiving a packet;
storing the packet into a packet buffer;
analyzing the packet to determine a processing manner of the packet; and
when determining that the packet needs to be processed by software, merely delivering a partial content of the packet to a memory, for analysis by a processor.

12. The operating method of claim 11, wherein the partial content of the packet comprises a header of the packet.

13. The operating method of claim 11, wherein the step of merely delivering the partial content of the packet to the memory comprises:
delivering a content with a fixed length starting from a header within the packet into the memory.

14. The operating method of claim 11, wherein the step of merely delivering the partial content of the packet to the memory comprises:
deciding a transmission length according to a frame/packet type of the packet, and delivering the partial content having the transmission length within the packet into the memory.

15. The operating method of claim 11, wherein the step of merely delivering the partial content of the packet to the memory comprises:
deciding a transmission length according to importance or a priority of the packet, and delivering the partial content having the transmission length within the packet into the memory.

16. The operating method of claim 11, wherein the step of merely delivering the partial content of the packet to the memory comprises:
deciding a transmission length according to a frame/packet type of the packet and/or importance or a priority of the packet, and delivering the partial content having the transmission length within the packet into the memory.

17. The operating method of claim 11, further comprising:
after the control circuit delivers the partial content of the packet to the memory via the processor port, and after a notification from the processor is received, correcting the packet stored in the packet buffer according to a corrected content of the partial content stored in the memory which is corrected by the processor, to generate a corrected packet; and
forwarding the corrected packet to an electronic device outside the network device.

18. The operating method of claim 11, wherein after a partial content of the packet is delivered to the memory, the packet buffer stores complete contents of the packet.

19. The operating method of claim 11, further comprising:
segmentally delivering data contents following the partial content to the memory via a processor port, until the processor does not need to analyze subsequent data or all contents of the packet have been delivered to the memory.

20. The operating method of claim 11, further comprising:
in response to a request of the processor, delivering the remaining contents of the packet to the memory via a processor port, for being analyzed by the processor.
